(19) United States
(12) Patent Application Publication
(10) Pub. No.: US 2012/0109618 A1
(43) Pub. Date: May 3, 2012

(54) ACCIDENT PARAMETER IDENTIFICATION METHOD FOR SEVERE ACCIDENTS

(75) Inventors: Chih-Ming TSAI, Taoyuan (TW); Shih-Jen WANG, Taoyuan (TW)

(73) Assignee: INSTITUTE OF NUCLEAR ENERGY RESEARCH, ATOMIC ENERGY COUNCIL, EXECUTIVE YUAN, Taoyuan (TW)

(21) Appl. No.: 13/272,324

(22) Filed: Oct. 13, 2011

(30) Foreign Application Priority Data
Nov. 2, 2010 (TW) 099137666

(51) Int. Cl. G06G 7/54

(52) U.S. Cl. 703/18

(57) ABSTRACT

The present invention discloses an accident parameter identification method, combining optimization algorithm and severe accident analysis software, for severe accidents. The optimization algorithm and severe accident analysis software are compiled into individual applications. The process for parameter identification is decided by the optimization algorithm. The actual accident parameter can be obtained by minimizing the difference between the calculations and the actual signals in the nuclear power plant.

### FIELD OF THE INVENTION

The present invention relates to a method, combining an optimization algorithm and a severe accident analysis software, for identifying the parameters of a severe accident of a nuclear power plant.

### BACKGROUND OF THE INVENTION

After the Three Mile Island (TMI) accident in the United State in March, 1979, the nuclear industry is aware of that light-water reactor core could be meltdown in severe accidents. Meanwhile, the TMI experience shows that proper and in-time emergent responses can mitigate or even eliminate the accidental impact on public safety. Therefore, the nuclear industry, regulation enforcement and power utilities all invested huge manpower and resources in studying the physical and chemical phenomena in the power plant during severe accidents. It makes an epochal change for plant operations, nuclear regulations, and nuclear safety. In order to avoid or eliminate the impact of the severe accidents on public safety, not only plant operations and safety evaluation are improved, but also the severe accident analysis software is developed to figure out the accidental sequence and to find out useful response strategies with the available equipments of the power plant to mitigate the severe accidents. The Emergency Operating Procedure (EOP) and Severe Accident Management Guide (SAMG) for each power plant are also established.

Generally, power plants should follow EOP or SAMG to carry out the strategies for mitigating the accidental severity Take the Maanshan nuclear power plant in Taiwan for example. When the water level of Steam Generator (S/G) is lower than 71.2% (SAG-1), the water injection is required in order to protect the S/G tubes, wash out fission products in the S/G tubes, and provide a heat sink for the Reactor Coolant System (RCS). If the situation keeps getting worse and the RCS pressure is higher than 28.12 kg/cm² (SAG-2), then the RCS depressurization is required to terminate or mitigate the accident consequence.

It's believed that the strategies in EOP and SAMG identified through lots of safety researches might have less impact. However, the most essential strategy is still to minimize the impact from accidents through identifying the accident characteristics in the first stage and finding out the appropriate action after.

After the TMI accident, it takes long-time and large-scale researches to understand the physical and chemical phenomena in the power plant during severe accidents. Many severe accident analysis programs are developed based on the studies. For example, the MELCOR program was developed by the Nuclear Regulatory Commission (NRC) and the MAAP program was developed by the Electric Power Research Institute (EPRI). Many reports for severe accident analysis were implemented with the programs mentioned above. In 2002 Chien-Chin Chen and Min Lee used MAAP 4.0.4 to simulate the severe accidents of the Lungmen nuclear power plant and studied the physical phenomena of the containment during severe accidents. In 2003 Wang et al. used MAAP v4.0.4 to simulate the station blackout (SBO) accident of the Maanshan nuclear power plant with introducing the SAMG strategies. In 2004 Vierow et al. used MELCOR, MAAP4 and SCDAP/RELAP5 programs to simulate the SBO accident of a PWR plant and compared the results from these three programs. Yoo et al. used the MAAP4 program to simulate and study the RCS depressurization of a Korea PWR with introducing the SAMG.

In order to determine the accident parameters in the first stage of a loss-of-coolant accident (LOCA) of the Kuosheng nuclear power plant, Chun-Sheng Chien and Shih-Jen Wang incorporated the codes of Simplex optimization algorithm into the MAAP4 software as a parameter identification program in 2008. The study entitled “Development of Parameter-Identification Capability for MAAP4 Code” is published in the Nuclear Technology. It's shown that the break elevation and break area of a postulated LOCA of the Kuosheng nuclear power plant can be successfully identified with the actual plant signals by the parameter identification program. The paper also shows that the program development may take tedious works and much effort on ensuring that all variables at the beginning of every accident simulation are identical except for the adjusted accident parameters.

MAAP program is comprised of massive and complex computing codes. It can simulate the responses of nuclear power plants of light water reactor. Except for the generic variables, the MAAP models of BWR and PWR plants are different, i.e. plant-specific feature. Furthermore, different severe accidents bring in different evolutions of power plant status. For example, in a line break accident, high temperature steam in the RPV releasing through the break to drywell leads to high drywell pressure. In a SBO accident the high temperature steam in the RPV is released to the suppression pool through relief valves while the RPV pressure above the pressure set point of valves. It increases the water temperature of the suppression pool. These show the accident-specific feature.

According to the discussions in the abovementioned two paragraphs, it could be anticipated that if the same method was used to develop an accident parameter identification program for the anticipated transient without a scram (ATWS) accident of the Kuosheng nuclear power plant, the tedious works and much efforts on programming are required due to the accident-specific feature. If the same method was used to develop the parameter identification program for the LOCA of the Maanshan nuclear power plant (PWR), the same challenge we should face due to the plant-specific feature. Even more, in cases of upgrading the severe accident software or plant models, all running parameter identification programs need to recheck all variables at the beginning of every accident simulation identical except for the adjusted accident parameters.

It is obvious that the idea of integrating the optimization algorithm and the severe accident analysis software for parameter identification is not easily extended in the field of nuclear industry if the current method is used.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

The present invention is a method of combining an optimization algorithm and a severe accident analysis software as a computer aided tool for identifying power plant accident parameters. Features and functions of the method are: 1. the optimization algorithm and the severe accident analysis software are compiled into independent applications; 2. modifying the source codes of the severe accident analysis software is not required so that the plant- and accident-specific features, and updating the computer aided tools as upgrading software are eliminated; 3. it's appropriate to develop parameter identification tool for any of severe accidents in power plants; 4. it makes a easy development of parameter identification tool and the idea of combining an optimization algorithm and a severe accident analysis as a computer aided tool for identifying parameters of a severe accident of the power plant widely applied in the field of nuclear industry; and 5. various optimization algorithms and severe accident analysis software are appropriate.

In order to meet the goals mentioned above, the accident parameter identification method for severe accidents in the present invention includes the steps of: a) selecting a severe accident analysis software and setting a search range or an initial value of each accident parameter for an optimization algorithm; b) updating an input file of the severe accident analysis software; c) executing a severe accident simulation with the severe accident analysis software; d) outputting a simulated response of a power plant; e) obtaining actual power plant signals; f) evaluating difference between the simulated response and the actual power plant signals; g) checking whether a difference meets prescribed criteria; and h) identifying the accident parameters for the power plant if the difference meets the prescribed criteria; updating the accident parameters through the optimization algorithm and repeating steps b) to h) if the difference doesn't meet the prescribed criteria.

Preferably, the severe accident analysis software includes MAAP, MELCOR, or SCDAP/RELAP5.

Preferably, steps f), g) and h) are processed by an optimization algorithm.

Preferably, the Simplex optimization algorithm is used.

Preferably, the optimization algorithm is programmed.

### BRIEF DESCRIPTION OF THE DRAWINGS

FIG. 1 is a flowchart of an embodiment of the present invention.

### DETAILED DESCRIPTION OF THE PREFERRED EMBODIMENT

The present invention will now be described more specifically with reference to the following embodiment. It is to be noted that the following descriptions of preferred embodiment of this invention are presented herein for purpose of illumination and description only; it is not intended to be exhaustive or to be limited to the precise form disclosed.

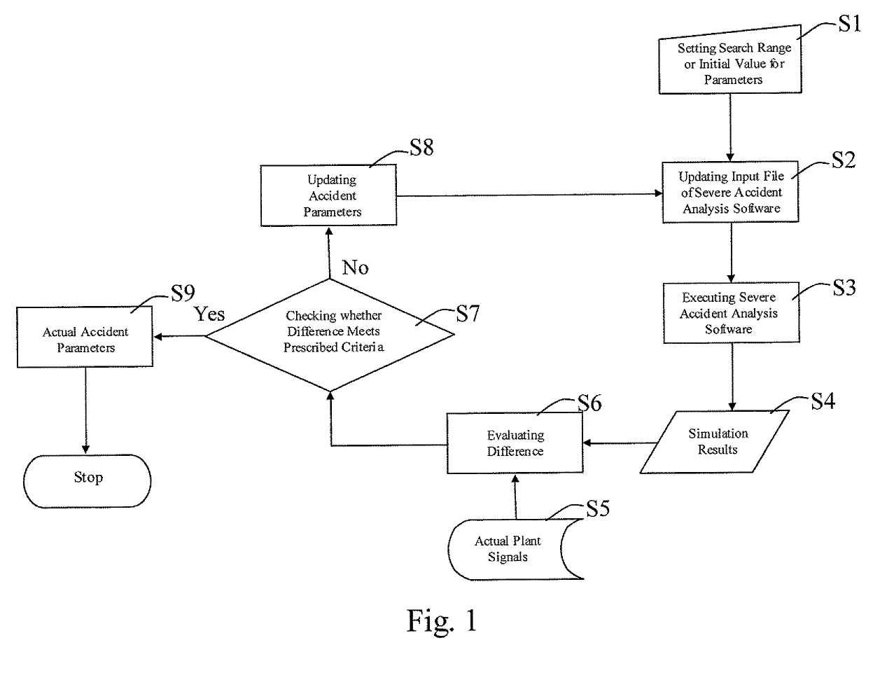

An embodiment of the present invention can be illustrated by a flowchart as shown in FIG. 1. Please refer to FIG. 1. Before the embodiment is illustrated, a simple introduction for the severe accident analysis software used in the present invention is made.

The common severe accident analysis software, such as MAAP, MELCOR or SCDAP/RELAP5, is comprised of massive and complex computing codes. The programmer needs to comprehensively understand the power plant and accident features, and the software in order to modify the source codes. Take the severe accident analysis software, MAAP, used in the present embodiment for example and assume the source code is not modified. An input file, parameter file, restart file, report template file and graphics input file, totally 5 files, could be inputted for one MAAP run. The input file and parameter file are necessary and indispensable in running MAAP. The input file defines the scenario of the severe accident, e.g. SBO accident, LOCA, ATWS accident, etc., staff operations, the directives to call the MAAP4-GRAAPH, and control logics. In addition, some variables in the parameter file can be updated in the input file.

The parameter file defines the equipments and designs of a power plant, such as reactor core power, fuel mass, cooling water flow and containment volume, and all parameters used in physical and chemical models of MAAP. The restart file is an output file. It records the simulated results of the power plant at the time users specified. The simulation can thus be restarted at the specified time with the restart file, instead of starting the simulation afresh. The calculating results are outputted in the form defined in the report template file.

The MAAP program also provides a GUI to display the transient plant status synchronously representing the MAAP calculations. Meanwhile, the important parameters are displayed at the lower of the monitor.

The spirit of the present invention is to simplify the process of minimizing the discrepancy between the MAAP simulations and actual plant signals for identifying the actual accident parameters. Updating the input file repetitively, executing the MAAP simulation, evaluating the difference between simulations and actual signals, checking whether the difference meets the prescribed criteria, and updating the adjusted accident parameters are controlled by the optimization algorithm until the actual accident parameters are identified.

Take the parameter identification for one unknown, assuming core temperature, at the steady state for example. The parameter file is plant-specific and never changed. The initial guess of 540 K of the unknown parameter (could be viewed as accident parameter) is set for the optimization algorithm (S1). The core temperature is updated in the input file (S2) and executing the MAAP simulation is followed (S3). While the MAAP simulation is completed and the core temperature supposedly increases up to 559.267 K at steady state (S4). The optimization algorithm, assume the Simplex algorithm in this case, evaluates difference (S6), between the simulation result and the core temperature of 553.2 K of actual plant signal obtained (S5). The Simplex algorithm also checks whether the difference meets the prescribe criterion (assume 0.2% in this case) (S7). The unknown parameter is successfully identified if the difference meets the prescribed criterion (S9); and if the difference does not meet the prescribed criterion, i.e., the current parameter is not the actual accident parameter, the core temperature is updated by the Simplex algorithm (S8) and updating the input file is followed (S2). Steps S2 to S8 are repeated until the difference meets the prescribed criterion, i.e. the actual accident parameter is identified.

It should be noted that the present invention is not limited to steady-state calculations. The present invention can definitely be used to develop parameter identification programs for severe accidents, such as LOCA, through minimizing the difference between simulations from a severe accident program and the actual plant signals by an optimization algorithm. The unknown accident parameters can be adjusted with an initial guess and/or searching ranges by an optimization algorithm. Meanwhile, one or more unknown accident parameters are accepted for the present invention. The severe accident analysis software includes not only MAAP but also MELCOR, SCDAP/RELAP5, etc.

The present invention makes the optimization algorithm and severe accident analysis software as individual applications. In this way the plant- and accident-specific features are removed due to the elimination of modifying the source codes of the severe accident analysis software. Also, updating the developed parameter identification programs as upgrading the severe accident analysis program is not required. It's believed that the present invention has advantages of easily developing parameter identification programs for any of severe accidents in power plants, widely extending the ideal of combining an optimization algorithm and a severe accident analysis program as a computer aided tool for accident parameter identification, and not only the specific optimization algorithm and severe accident analysis software are accepted.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An accident parameter identification method for severe accidents, comprising the steps of
a) selecting a severe accident analysis software and setting a search range or an initial value of each accident parameter for an optimization algorithm;
b) updating an input file of the severe accident analysis software;
c) executing a severe accident simulation with the severe accident analysis software;
d) outputting a simulated response of a power plant;
e) obtaining actual power plant signals;
f) evaluating difference between the simulated response and the actual power plant signals;
g) checking whether a difference meets prescribed criteria; and
h) identifying the accident parameters for the power plant if the difference meets the prescribed criteria; updating the accident parameters through the optimization algorithm and repeating steps b) to h) if the difference doesn't meet the prescribed criteria.

2. The accident parameter identification method for severe accidents as claimed in claim 1, wherein the severe accident analysis software comprises MAAP, MELCOR, or SCDAP/RELAP5.

3. The accident parameter identification method for severe accidents as claimed in claim 1, wherein steps f), g) and h) are processed by an optimization algorithm.

4. The accident parameter identification method for severe accidents as claimed in claim 3, wherein the optimization algorithm is Simplex algorithm.

5. The accident parameter identification method for severe accidents as claimed in claim 3, wherein the optimization algorithm is programmed.
